(19) United States
(12) Patent Application Publication
(10) Pub. No.: US 2012/0166283 A1
(43) Pub. Date: Jun. 28, 2012

(54) Internet Web-Based Online Dispute Resolution System

(76) Inventor: Robert Alan Berliner, Las Vegas, NV (US)

(21) Appl. No.: 12/964,150

(22) Filed: Dec. 28, 2010

(51) Int. Cl. G06Q 99/00; G06Q 30/00

(52) U.S. Cl. 705/14.58

(57) ABSTRACT

An automated, anonymous, universally available, Internet-based online system to assist with dispute resolution for entities of all types, including individuals, business entities, religious entities, government entities, educational entities and any other types of entities that may be involved in a dispute. It provides dispute resolution assistance for disputes that may be either personal or public in nature, and for disputes over financial or non-financial issues. The system does not render verdicts or determine winners or losers: it suggests methods which may amicably lead to the resolution of disputes outside of the traditional means, systems and methods, which include mediation, arbitration, and the court system.

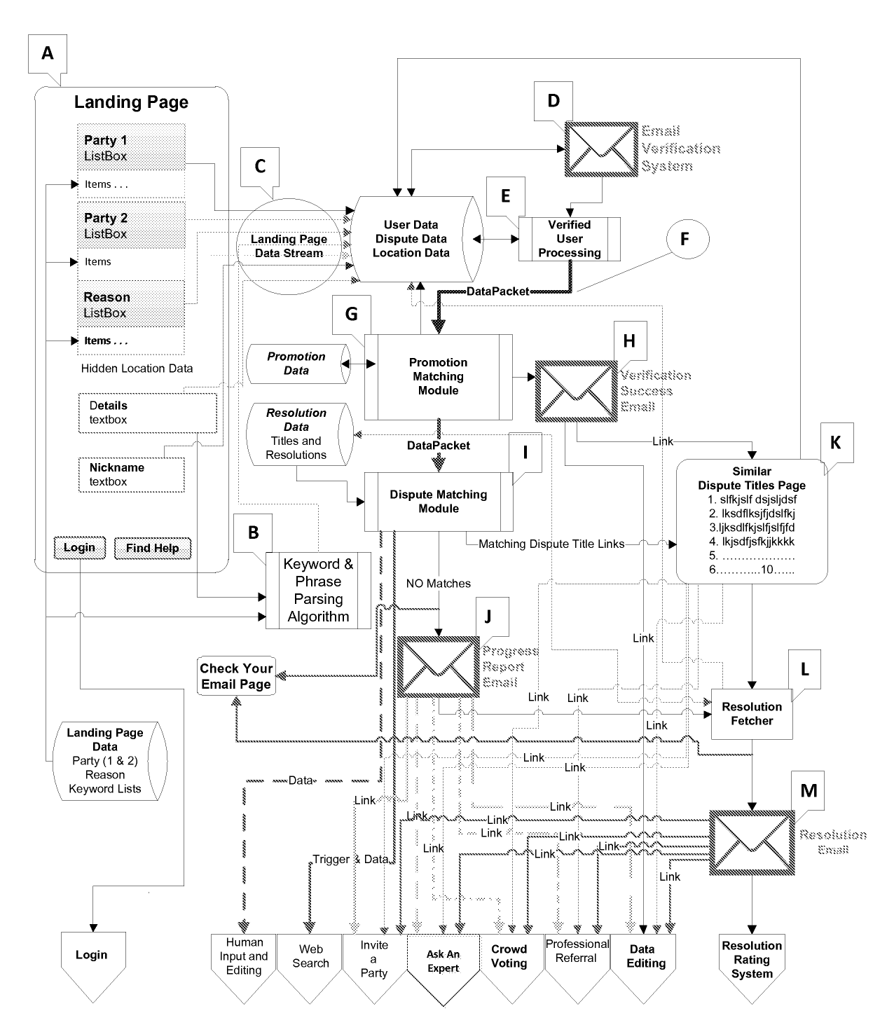

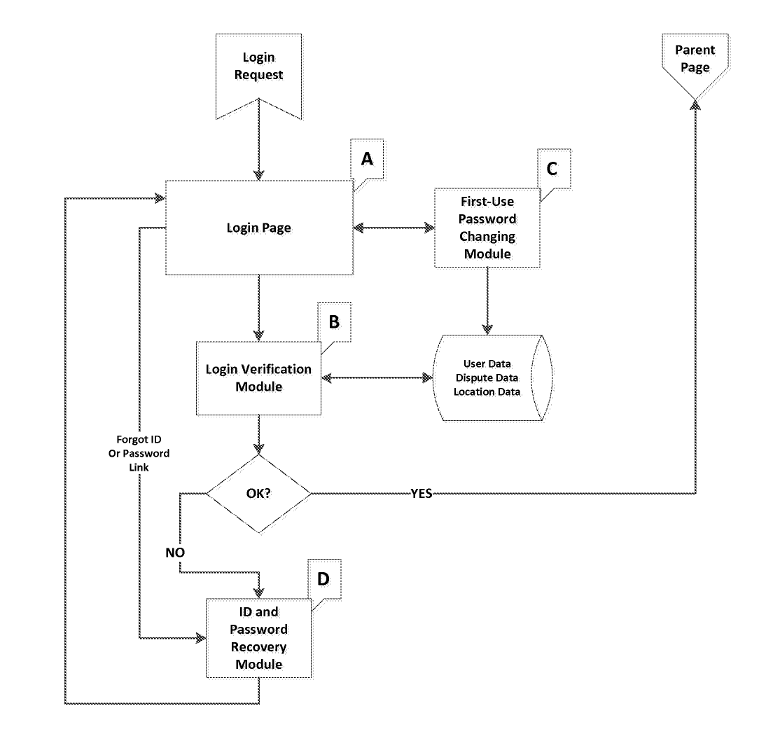

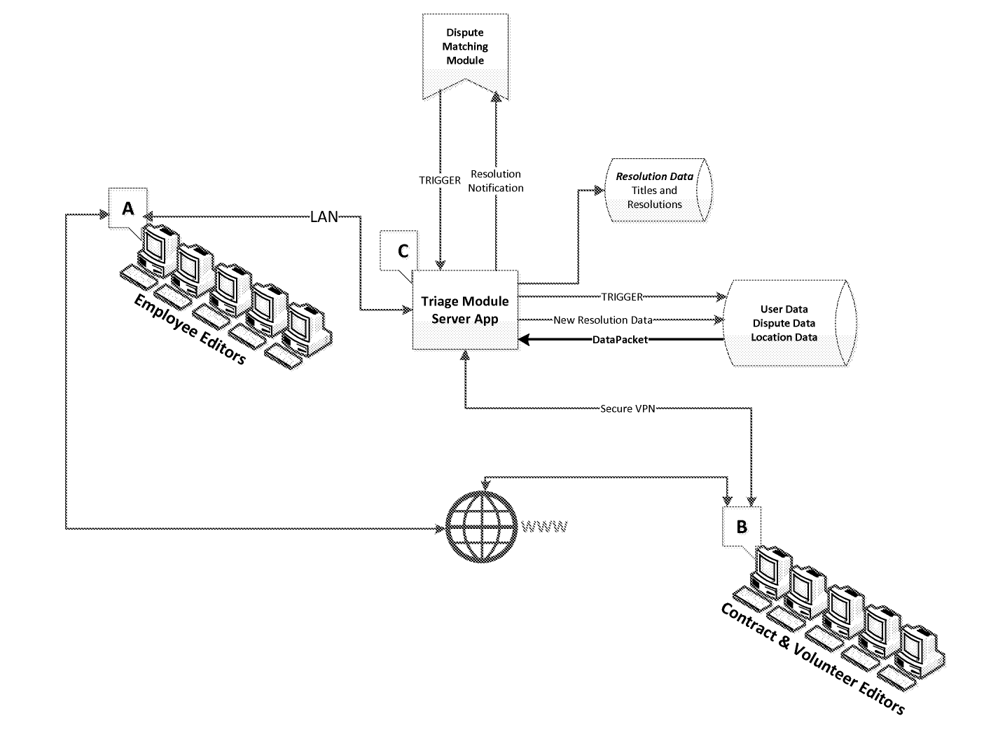

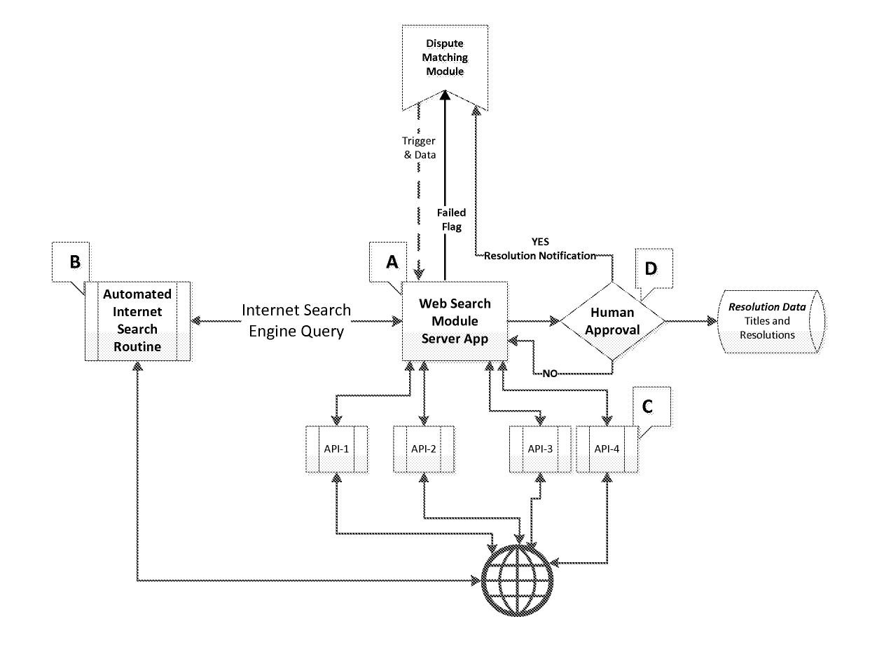

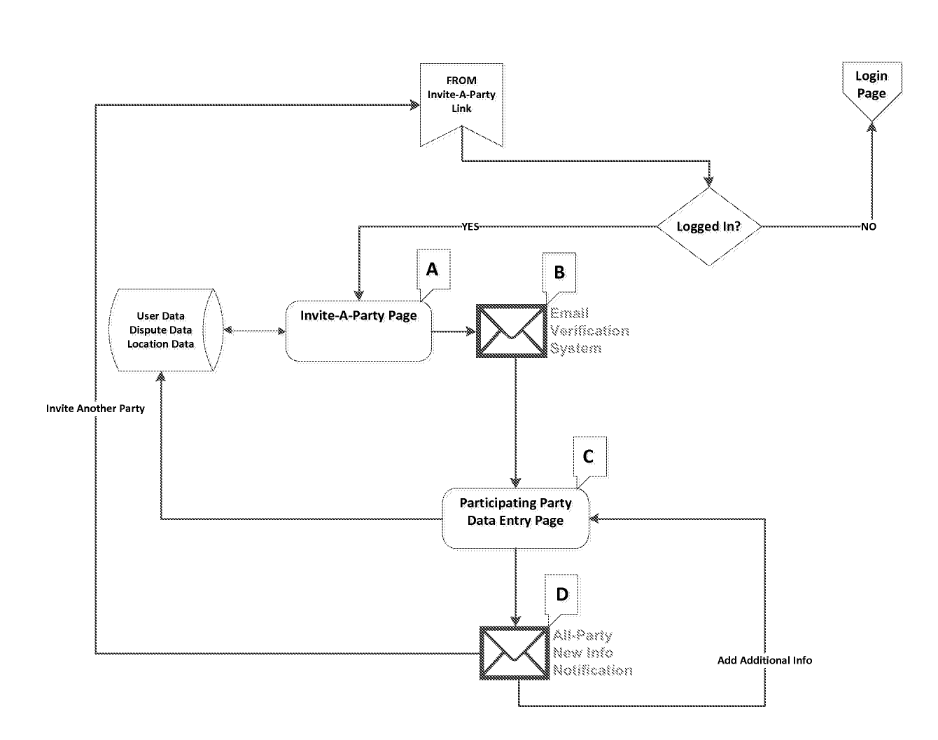

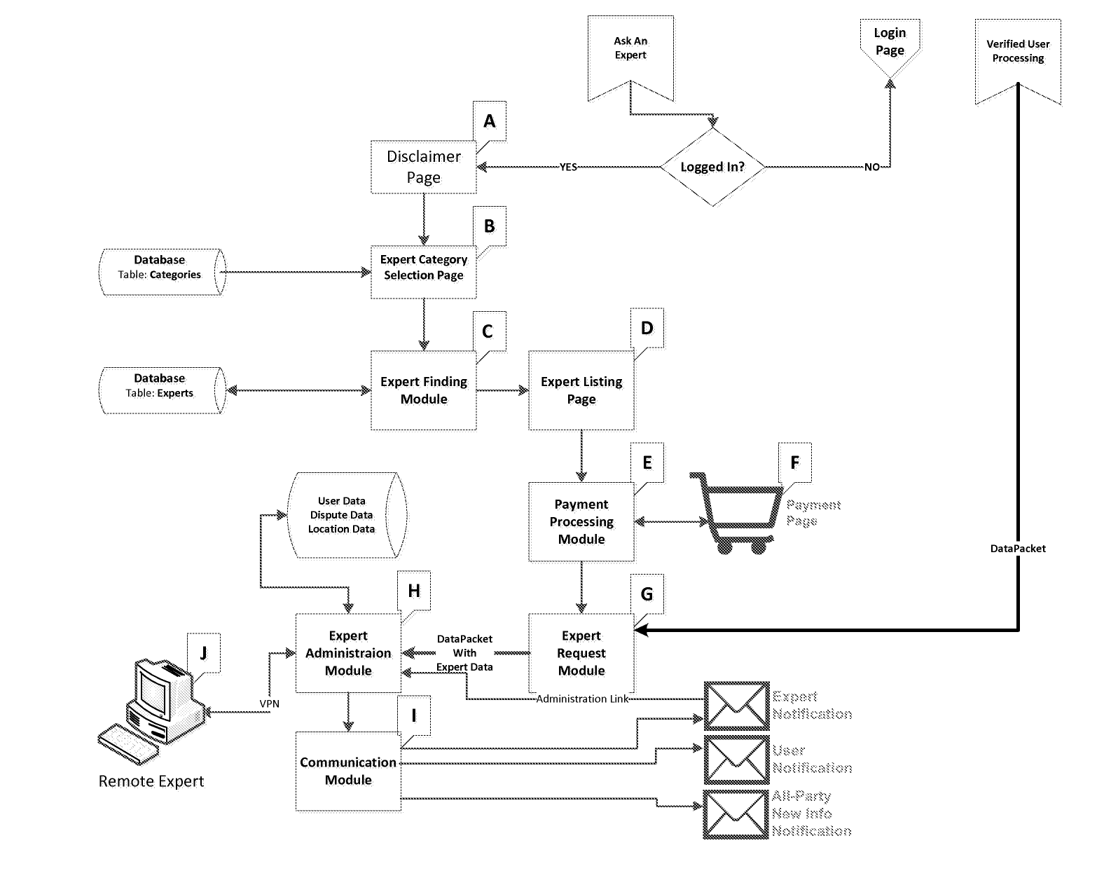

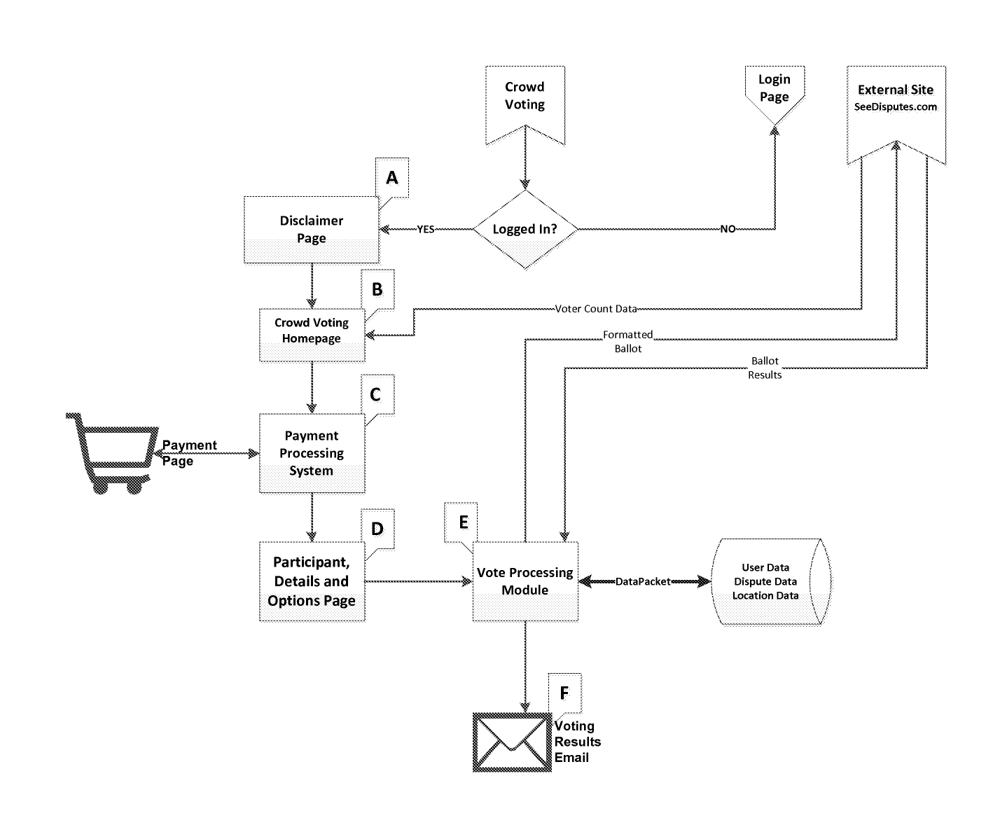

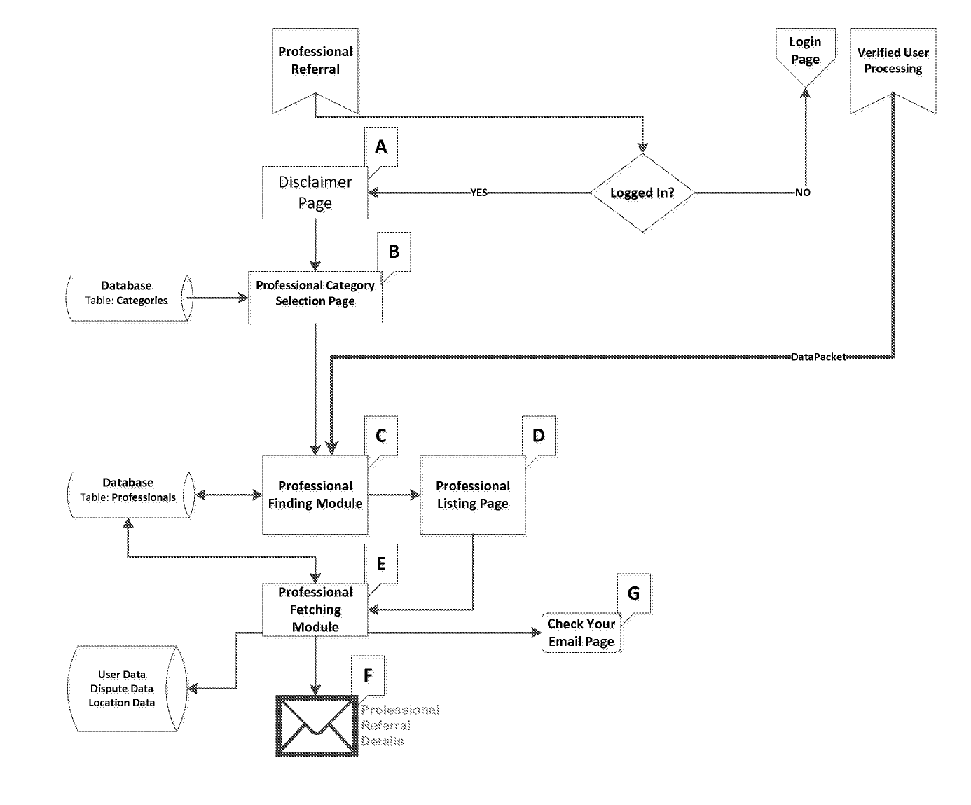

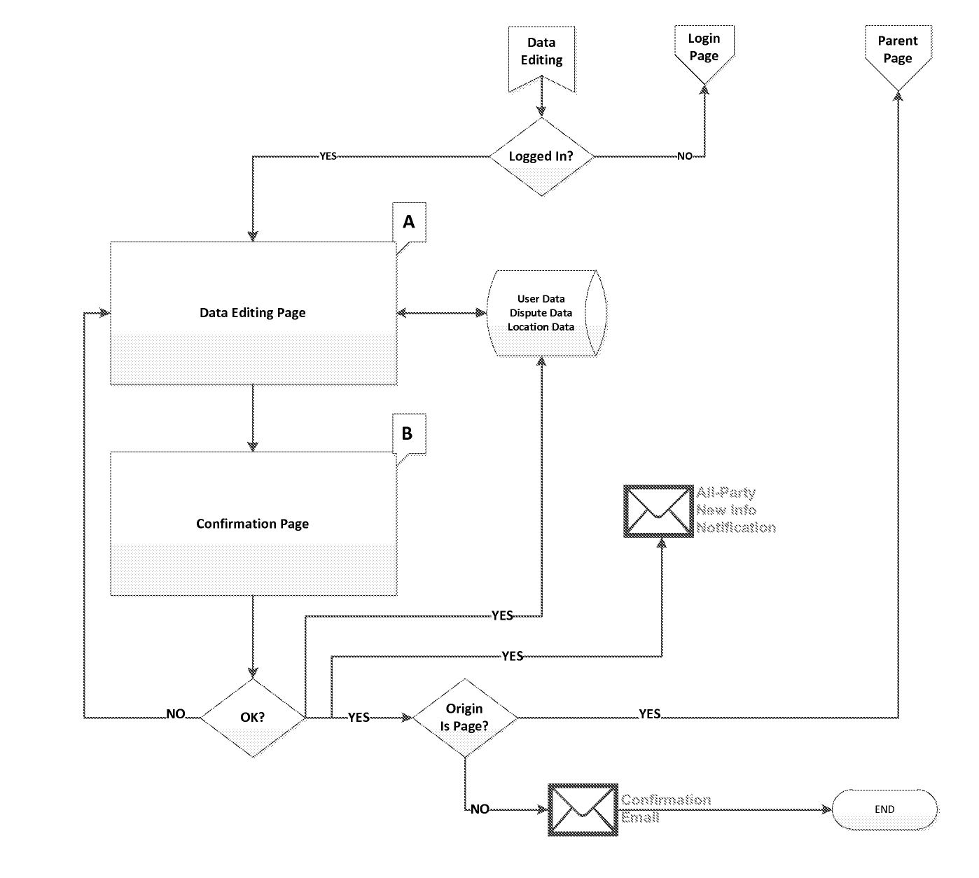

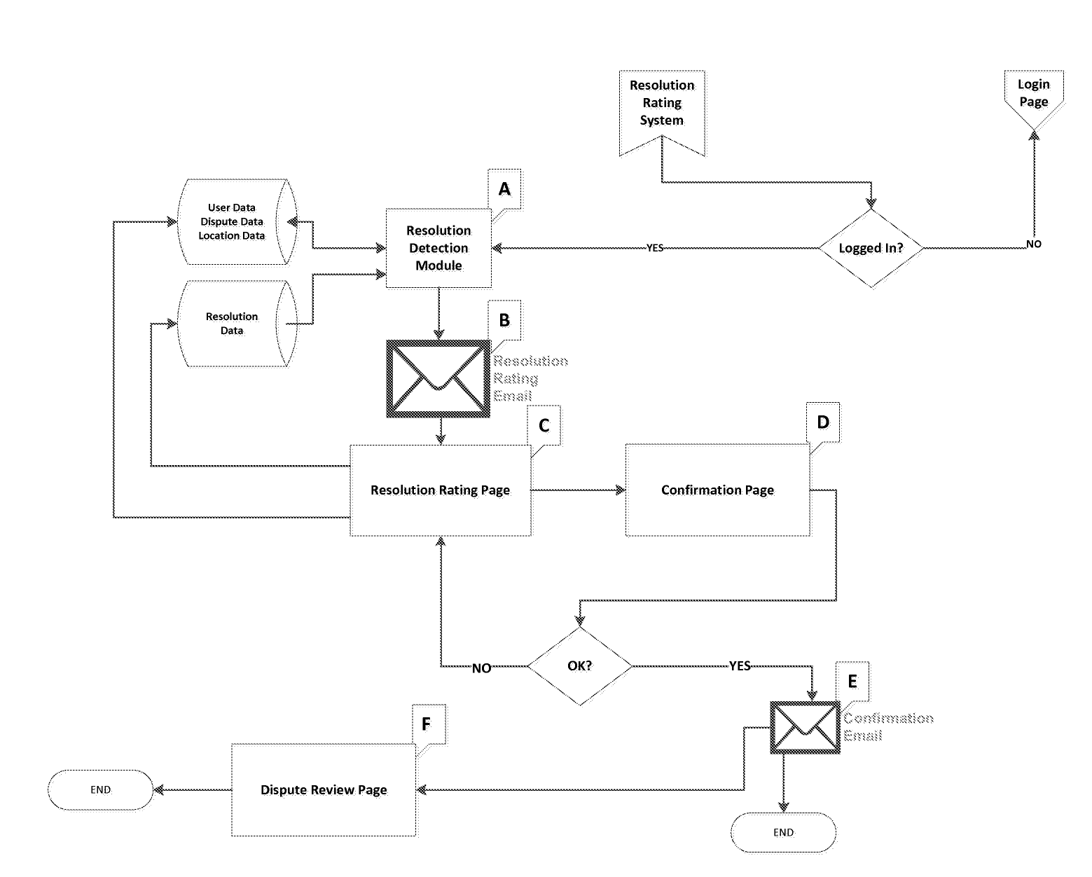

### BACKGROUND OF THE INVENTION

Disputes between entities of all types have increased significantly. Presently there is no automated Internet-based online system which can informally assist anonymous parties to a dispute by offering automated resolution suggestions. This invention provides several methods by which disputing entities can quickly seek and receive suggested resolutions for disputes ranging in nature from personal to international for both financial and non-financial issues.

### BRIEF SUMMARY OF THE INVENTION

The invention is an online system to assist with dispute resolution for entities of all types, including individuals, business entities, religious entities, government entities, educational entities and any other type of entity that may become a party to a dispute. Additionally, there is no requirement that the dispute be about anything in particular. The system's only prerequisite is that there must be a dispute: a disagreement between two or more parties. It is not, and not to be confused with, a forum for complaints or gripes. It does not contain any requirement that the reason for the dispute be about an online or in-person purchase of goods or services. The system will assist in the resolution of disputes that may be personal, commerce or ecommerce based, local, national or even international in scope. This system differs from other online systems in that it is designed to accommodate any size dispute, from a single party unilateral dispute to a dispute involving an unlimited number of parties. It renders suggested dispute resolutions via one or more of six different sources: resolutions stored in a proprietary database, resolutions suggested by human editors, resolutions derived from an automated web search, resolutions suggested by a qualified expert, resolutions suggested by ballot, and resolutions through professional referrals. This invention is not a negotiation tool and does not deal with specific details of any dispute, but instead provides generalized suggestions regarding how disputes of similar nature have been resolved by others in the past, and suggestions regarding how a first-time dispute may be resolved. The invention is also unique in that users of the automated dispute resolution system remain anonymous: the user's identity is never requested, stored or associated with a dispute. If an optional paid service is purchased for which credit card information is required, that information is never stored nor associated with a user or a dispute.

The reasons such a service would be widely embraced include:
1. Disputing parties' wish to remain anonymous. Currently available methods of dispute resolution do not provide anonymity.
2. Disputing parties' desire for instant gratification. Currently available methods of dispute resolution ordinarily involve lengthy processes.
3. Excessive cost of traditional dispute resolution: Available methods of dispute resolution, even at the Small Claims Court level, are costly in both money and time.

This invention provides a solution addressing all three concerns.

The invention will be produced using the C# programming language and other commonly available web programming languages and tools. Its database technology will be Microsoft SQLServer and other commonly available database storage systems.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Drawing 1: Exhibit A—Resolution Flowchart: Depicts the automated dispute resolution flow process.

Drawing 2: Login Module Flowchart: Depicts the user login process.

Drawing 3: Human Input and Editing Flowchart: Depicts how human editors may assist the dispute resolution process.

Drawing 4: Web Search Process Flowchart: Depicts the automated web-based dispute resolution search process.

Drawing 5: Invite-A-Party Process Flowchart: Depicts the process by which additional parties are invited to join a dispute.

Drawing 6: Ask-An-Expert Process Flowchart: Depicts the process in which a user seeks the advice of an expert.

Drawing 7: Crowd Voting Process Flowchart: Depicts the process by which a user requests and receives the opinion of a number of anonymous online users, a.k.a. “crowd”.

Drawing 8: Professional Referral System Process Flowchart: Depicts how a user can seek the help of a professional to assist with their dispute resolution.

Drawing 9: Data Editing Process Flowchart: Depicts how a user can edit their entries pertaining to a dispute.

Drawing 10: Resolution Rating System Process Flowchart: Depicts how a user of the system can rate the value of resolution suggestions they received through the system.

### DETAILED DESCRIPTION OF THE INVENTION

### Description: Exhibit A—Resolution Flowchart

The flowchart titled Exhibit A—Resolution Flowchart contained within the included Flowcharts document as Drawing 1 is a detailed depiction of the process involved in rendering one or more suggested resolutions for a user-entered unilateral dispute. References to the accompanying flowchart are made with lettered notations.

### Universal Links

Every user-viewable element of the site may contain certain standard universal links which direct the user to additional functionality from virtually any point. Links will appear on web pages as well as emails and include:
Login: Redirects the user to the Login page. Login is required to access any system functionality other than entering a new dispute.
Invite Additional Party: Redirects the user to a web page allowing one or more parties to be added to an existing dispute.
Ask An Expert: Links user to the self-contained Ask an Expert application in which a pre-screened expert from an appropriate field is consulted for an opinion.
Crowd Voting: Other online users are anonymously polled for their collective opinion.
Professional Referral Service: A licensed professional is contacted through this portal and connected with the user to assist in their dispute resolution.
Data Editing: Redirects the user to a web page which displays all data entered for a dispute, then allows the user to edit or add data.
Terms and Conditions: Redirects the user to the Terms and Conditions page.
Privacy Policy: Redirects the user to the Privacy Statement page.
Sitemap: Links to the system sitemap.
About Us: Links to a page describing the company.
A) The Dispute Resolution Process begins on the Landing Page. On this page there are six data elements collected by the following controls:
   1. Party 1 ListBox
   2. Party 2 ListBox
   3. Reason ListBox
   4. Location Data hidden control
   5. Details textbox
   6. Nickname textbox

Returning users who want to access an existing dispute may click on the Login button control which will take them directly to the Login Page.

The Party 1 and Party 2 ListBoxes are programmatically populated with generalized party types from data stored in the Landing Page Data database, i.e. Person, Business, School, Government Entity, Religious Entity, etc., from which the user must select a single entry from each ListBox.

The Reason ListBox is programmatically populated by an algorithm that analyzes the Party 1 and Party 2 choices, and suggests logical generalized reasons of dispute for the selected party types.
Example: If the selection in Party 1 was “Person” and the selection in Party 2 was also “Person”, the generalized reasons two people might dispute would, amongst the possible choices, include “forgotten or missed occasion”. Conversely, a Reason which might not be offered in the list would be “overcharged for purchase”. An optional selection of “Other” would allow the reason to be manually entered.
Whereas, if the selection in Party 1 was “Person” and the selection in Party 2 was “Business”, the Reasons ListBox would include “overcharged for purchase” and would not contain “forgotten or missed occasion” amongst possible choices.

After selecting a Reason, the final required entry is in the Details textbox, which accepts freeform text of a minimum and maximum number of characters in length.

Next, the user is given the option to enter a Nickname of their choice. Nicknames are unique only to a specific dispute, therefore the originating party, as the first party to a dispute, may enter any nickname. Nicknames are used only to associate entries in a particular dispute with a specific anonymous participant in that dispute. If a Nickname is not entered by the user, the system will programmatically assign one. Nicknames are only important in disputes with more than a single party, but will always be stored so if a dispute later becomes bilateral or multilateral (additional parties are added), each party will have a unique nickname.

The Hidden Location Data control is invisible to the user and requires no user interaction. It programmatically collects data pertaining to the user's location, later saved and associated to their User Data record.

After completing all required entries, the Find Help button is activated, allowing the user to proceed to the next step.
B) Clicking the Find Help (submit) button triggers the following actions:
   1. All data collected on the Landing Page, collective referred to as the Landing Page

Data Stream (see “C” below) is stored in the appropriate tables contained within the User Data database.
2. The Keyword & Phrase Parsing Algorithm compares text entered into the Details

Textbox by the user against keywords and phrases stored in a Landing Page Data database table. If a match is found it is parsed (separated) then saved as part of the user's data record in the User Data database.
Examples of Keywords and phrases are: mother, father, DUI, driving while intoxicated, house, IRS, kid, Chapter 11, girl, boy, teenager, car, Chevrolet, Chevy Corvette, pain, bank foreclosure, tire failure, hospital, etc. Examples of words which will be ignored are: the, and, if, any, etc.

The keyword or phrase may be assigned a dispute value parameter and or a market value parameter.
Example of Dispute Values: Car=2 because it describes a “thing” which likely has some significance in the dispute, whereas the value for Chevy=5 because it describes a Make of Car and has a greater likelihood of significance to the dispute, and the value of Chevrolet Corvette=8 as it describes a Make and Model of a Car and therefore is very likely to have some significance in the dispute.
Examples of Market Values are: Car=$0.25 signifying that a location-based value of a lead for a dispute that may involve a car is worth $0.25, whereas a lead which mentions a Chevy may be worth $0.75 since Ford dealers may value leads in which people are having disputes which include ‘Chevy’ as an element. In the case in which a particular Make and Model are mentioned, like ‘Chevrolet Corvette’, an authorized Chevrolet Dealer servicing that location is which the dispute was filed may have an interest in the lead to either nip-in-the-bud and issue or capitalize upon one in which an unhappy consumer can be up-sold. In such a case a single lead may be worth several dollars or more.
C) The Landing Page Data Stream includes every data collected on the Landing Page as well as data pre-processed by the Keyword & Phrase Parsing Algorithm. Data is stored into a temporary record in the User Data database. The record becomes permanent only upon verification of the user's email address, below.
D) The Email Verification System prompts the user to enter their email address in duplicate, correctly enter a CAPTCHA code, and check a checkbox acknowledging the Terms and Conditions and Privacy statements. The following tests are applied prior to the user being allowed to proceed:
   1. Email format is acceptable=True
   2. Emails are identical=True
   3. CAPTCHA code verification=True
   4. Acceptance of Terms and Conditions and Privacy acknowledgment=True

After passing the four tests, an email containing a unique verification link is sent to the user. The user completes the verification process by either clicking the link or copy-and-pasting it into a browser then navigating to the URL. After successful verification a timestamp is appended to the previously created temporary user data record and it is flagged as permanent, after which the Verified User Processing module is triggered.

Once verified, the user is redirected to a page acknowledging verification. No entry or action of any kind is required on this page. The page contains option buttons allowing the user to return to the Landing Page or to ‘See Some Deals’. Both actions are optional.
E) The Verified User Processing module performs the following functions:
   1. It assigns a User/Dispute ID and password linked exclusively to the user, the dispute, and the user's nickname.
   2. It updates the User Data database table with the data in Step 1, above.
   3. It fetches the required data from the permanent user data record in the User Data database.
   4. It constructs the DataPacket.
   5. It sends the DataPacket to the Promotion Matching Module.
F) The DataPacket includes, by reference, the user's email address, location data, three ListBox selections, parsed keywords and phrases and their values, plus the unabridged text entered into the Details Textbox.
G) The Promotion Matching Module matches data from the DataPacket with active records contained within the Promotion Data database. Promotion matches are based upon location and metrics specified by the providing company. Example: 1-800-FLOWERS will pay 5 cents for each “$20 OFF” coupon attached to a personal dispute within 25 miles of zip code 89108 during the month of February 2011. Each time a promotion is “spent”, the Promotion Matching module increments a counter in the promotion record and sends a record of the promotion's ID to the record in the User Data database, allowing promotion tracking to the user level. After appropriate promotions have been matched to a dispute, the following actions are triggered:
   1. The Verification Success Email is sent.
   2. The DataPacket is passed to the Dispute Matching module.
H) The Verification Success Email contains:
   1. A unique dispute code, the user's nickname, and a temporary password with which the user can login to the dispute for the first time only. The user is required to change the password to one of their choosing upon their first login.
   2. A summary of the dispute data with a link to the Data Editing module, which provides the option to add data to the dispute.
   3. Generic Resolution Suggestions: Helpful non-specific suggestions useful in resolving disputes.
      Example: “Cool off—sometimes just allowing a cooling off period helps opposing parties become more conciliatory.”
   4. A link to the Similar Disputes Titles Page (see “K” below).
   5. Relevant location-based promotions injected by the Promotion Matching Module.
I) The Dispute Matching Module is where data within the DataPacket is queried against the titles of resolutions stored in the Resolutions database table. There are two possible results:
   1. Up to 10 similar dispute titles, each with at least one suggested resolution are identified, ordered by relevance based upon the number of DataPacket matches, and sent to the Similar Dispute Titles Page; or,
   2. No relevant matches are found, in which case:
      a. The user is sent a Progress Report Email (see “J” below).
      b. Two alternate resolution finding paths, the Web Search and the Human

Input and Editing modules are triggered. Details contained in the DataPacket are made available to these modules.
c. The user is redirected to the Check Your Email Page.
J) The Progress Report Email:
   1. Informs the user that an alternate resolution search is underway and alerts them that they will receive another email as soon as resolution suggestions are located.
   2. Contains additional Generic Resolutions.
   3. Describes how the resolution process works.
   4. Provides brief descriptions of available alternative services, i.e. Ask-An-Expert, Professional Referral System, and Crowd Voting.
   5. Universal links as described on Page 4 of this document.
K) The Similar Disputes Titles Page displays the results of the Dispute Matching Module. It consists of links to stored similar-sounding disputes for which resolutions have already been suggested. Displayed results are displayed in a ranked order based upon how closely they are matched to what the user entered on the Landing Page. Clicking a similar dispute link triggers the Resolution Fetcher.

The user may also avail themselves of the functions accessible via the Universal Links described on Page 4 of this document.
L) The Resolution Fetcher performs a query against the Resolution Data database, then completes the following functions:
   1. It finds up to 10 suggested resolutions in sorts them into a ranked order.
   2. It sends the results to the Resolution Email module.
   3. It updates the related records in the Resolution Data database, indicating that a specific title has been searched for its suggested resolutions.
   4. It updates the user record In the User Data database to reference the specific resolutions that have been proposed for that user/dispute.
   5. It triggers the Check Your Email Page.
M) The Resolution Email contains results generated by the Resolution Fetcher. Results are full text suggestions detailing methods used by others to resolved similar disputes. They are delivered in ranked order based upon the resolution's reported success in helping previous users resolve similar disputes.

The Resolution Email contains location-based promotional incentives as well as the Universal Links outlined in Page 4 of this document.

The Resolution Email triggers the Resolution Rating System described separately in the section titled: Resolution Rating System Flowchart which begins on Page 27 of this document.

### Description: Login Module Flowchart

The flowchart titled Login Module Flowchart contained within the included Flowcharts document as Drawing 2 is a detailed depiction of the process involved for new users to login to the system. This process is only for users entering a new dispute. A user must be logged in to gain access to any of the functionality available to the parties to a dispute.

The Login Module provides the ability for a user to login and is triggered by either a user's intentional request to login by clicking the Login button on the Landing Page, selecting a Login link from any page or email in which the login link appears, or by attempting to access any protected function without being logged in. In the latter case the user will automatically be redirected to the Login module.

References to the accompanying flowchart are made with lettered notations.
A) A login request from any point in the system redirects to the Login Page. This page contains the following controls:
   1. ID Number: This is the unique generated when a dispute is first entered or a party is added. The number both identifies the dispute and the user.
   2. Password: This is the unique system-generated password paired with the ID Number.
   3. Login Button: This is the submit button which triggers the Login Verification Module.
   4. Forgot ID or Password Link: If a user forgets their ID or Password this link will redirect them to the ID and Password Recovery Module.
B) The Login Verification Module accepts the data entered in the Login Page and compares it to the User Data database. If the login is valid, the user is redirected to the parent page from which the Login Module was called. If the login is invalid, the user is redirected to the ID and Password Recovery Module where they will be able to recover a lost or forgotten ID or Password, or retry their login attempt without going through the recovery process.
C) Users logging in for the first time with a temporary password assigned by the system will be required to change the password to one of their choice. The First-Use Password Changing Module provides this functionality.
D) The ID and Password Recovery Module provides users with the ability to recover lost or forgotten ID's and passwords. Additionally, it contains a link allowing users to attempt another login without going through the recovery process.

### Description: Human Input & Editing Process Flowchart

The flowchart titled Human Input & Editing Flowchart contained within the included Flowcharts document as Drawing 3 is a detailed depiction of the process necessary to create a resolution suggestion for a dispute in which there is no suitable stored resolution. Entry into this process is triggered by the Dispute Matching Module based upon its failure to locate a suitable stored resolution.

References to the accompanying flowchart are made with lettered notations.
A) Employee Editors represent the top class of editors. Responsibilities include:
   1. Finding and storing suggested resolutions when suitable stored resolutions are not available in the Resolution Data database. Resolutions may be derived from:
      a. Personal knowledge and experience.
      b. Manual reference search.
      c. Internet search.
   2. Reviewing, editing where necessary, and categorizing resolutions suggested by Volunteer & Contract Editors, or by site visitors.

No resolution will be cleared for publication until an Employee Editor has approved it.
B) Contract & Volunteer Editors will work remotely, connected to the Triage Module Server App through a secure VPN connection

Contract & Volunteer Editors represent the rank and file class of editors. Responsibilities include:
1. Suggesting resolutions when suitable stored resolutions are not found in the Resolution Data database and Employee Editors are not presently available. Their suggestions may be derived from:
   a. Personal knowledge and experience.
   b. Manual reference search.
   c. Internet search.
2. Reviewing, editing where necessary, and categorizing resolutions suggested by site visitors and other casual sources.

No resolution will be cleared for publication until an Employee Editor has approved it.
C) The Triage Module Server App is triggered by the Dispute Matching Module upon its failure to find suitable matches for a user's dispute data entry.

It serves two primary functions:
1. Traffic Processor: All disputes entering the automated resolution process which ultimately require human intervention will be allocated to a specific human editor by the Triage Module Server App. The Triage Module Server App applies predefined logic to direct traffic in the following priority:
Editor Availability—Employee Editors, Contract Editors, Volunteer Editors
   Editor's location and localization relative to disputer's location
      Editor's Area of Expertise relative to subject matter of the dispute
         First In, First Out (FIFO)

Disputes will first be assigned to any available Employee Editor, then to any available Contract & Volunteer Editor, and last to a FIFO queue.
2. Data processor: Upon receiving notification of an unresolved dispute in need of human intervention via a trigger sent by the Dispute Matching Module, the Triage Module Server App fetches the DataPacket associated with the User Data database record reference contained within the trigger. The DataPacket is assigned to the Editor responsible for finding a resolution.

### Triage Module Responsibilities:

1. Track and maintain status of disputes assigned to Editors.
2. Assign every dispute touched by a Contract & Volunteer Editor to an Employee Editor for final approval.
3. Update the Resolution Data, Titles and Resolutions database tables with new or updated dispute resolution data.
4. Update the User Data database with the new suggested resolution references.
5. Notify the Dispute Matching Module that a new or updated resolution is now available triggering notification of all parties in the dispute.

### Description: Web Search Process Flowchart

The flowchart titled Web Search Process Flowchart contained within the included Flowcharts document as Drawing 4 is a detailed depiction of an automated process for locating and accessing dispute resolutions found on the Internet. Like the preceding Human Input and Editing module, it too is triggered by the Dispute Matching Module when no suitable stored resolution is found.

References to the accompanying flowchart are made with lettered notations.
A) The Web Search Module Server App accepts incoming data sent by the Dispute Matching Module, analyzes it, then determines which path or paths are most appropriate for locating a resolution. Then it constructs a properly formed and formatted inquiry relative to the chosen method(s).

The two primary categories of search methodology are:
B) Internet Search Engine Query. An automated programmatic Internet search routine accepts search criteria and searches for prospective resolutions anywhere on the Internet, then returns its results to the Web Search Module Server App.
C) Application Programming Interfaces (API's), both open source and licensed, to gain access to available data sources, i.e. Amazon, NY Public Library, Wikipedia, etc. Note that the referenced flowchart displays 4 API's, however there is no theoretical limit to the number of API's the Web Search Module Server App may access.

Possible results of both the Internet Search Engine Query and the Application Programming Interface queries are either success or failure, and are handled in a similar manner regardless of which search method was used.

Success: After prospective resolutions are located, data is programmatically vetted by the Web Search Module.

If the resolution(s) meet or exceed the minimum standards built into the Web Search Module Server App::
1. The resolution is associated with the original disputes title, or a title is created programmatically if none exists.
2. The title/resolution pair is sent to the Human Approval process for final acceptance.

Failure: If the resolution(s) fail(s) vetting it is recycled by the Web Search Module to try an alternate resolution finding method. This is repeated until all available methods are exhausted, after which the Web Search Module Server App returns a “failed” flag to the Dispute Matching Module, letting it know not to resend this exact dispute back for Web Search Module Server App for at least (n) days.
D) The Human Approval process is performed, as its name implies, by human editors (see “Human Input and Editing” above). Results from the Web Search Module Server App are sent to the Human Approval process, edited for clarity and accuracy, and if approved the appropriate record(s) in the Resolution Data database are updated.

If approval is declined, the search is sent back to the Web Search Module Server App for another try. Once (n) tries have resulted in failure the resolution will be flagged as “permanently rejected” and not reconsidered for processing within the Web Search Process.

### Description: Invite-A-Party Process Flowchart

The flowchart titled Invite-A-Party Process Flowchart contained within the included Flowcharts document as Drawing 5 is a detailed depiction of the process to invite one or more additional parties into the dispute. The process is triggered by the user's selection of a link on a page or a link contained within an email.

The Invite-A-Party module is available only to logged-in users who are presently a party to a dispute. Users not logged-in attempting to access this module will be programmatically redirected to the login page to login before being allowed to proceed.

The Invite-A-Party module provides the functionality necessary to invite additional parties to join a dispute. Any participating party may invite any additional party using the Invite-A-Party function. There is no limit to the number of parties that can be invited by any existing party; however, the only way to join a dispute is by invitation from a party already in the dispute. The invited party may be an ally, an opposing party, an interested party, or merely an observer.

References to the accompanying flowchart are made with lettered notations.
A) The user is initially directed to the Invite-A-Party Page. The page displays duplicate email entry textboxes, a dropdown list labeled “Interest” providing the user a method to describe the invited party's role or interest in the dispute, a textbox in which they may optionally specify a Nickname, a checkbox in which the user will accept the Terms & Conditions and Privacy Policies, and lastly with a CAPTCHA control.

If a Nickname is not provided by the user, one will be assigned by the system. The nickname must be unique only within the context of a single dispute. Unique users are identified by the system via their email address, not nickname. The nickname simply allows all participants and non-participating viewers to associate entries and comments as those of a specific participant without the user's email address being disclosed.

Nicknames are checked to ensure they are not already in use for that specific dispute.

Note: While it is highly improbable that two users would select the same nickname in a small dispute, it is possible that a single dispute may contain thousands of parties, making uniqueness crucial.

The “Interest” dropdown list will be populated via a database table containing static data terms such as, “Opposing Party”, “Interested Party”, “Friend of Initiating Party”, “Friend of Other Party”, “Observer”, etc.
B) The Email Verification System prompts the user to enter their email address in duplicate, correctly enter a CAPTCHA code, and check a checkbox acknowledging the Terms and Conditions and Privacy statements. The following tests are applied prior to the user being allowed to proceed:
   1. Email format is acceptable=True
   2. Emails are identical=True
   3. CAPTCHA code verification=True
   4. Acceptance of Terms and Conditions and Privacy acknowledgment=True

After passing all four tests, the user is sent an email containing a unique verification link. Upon verification, the user's programmatically ascertained location data and a timestamp are stored with the temporary data previously collected from the Invite-A-Party page. It is marked “permanent”, after which the Verified User Processing module is triggered.

After an added party is verified they become part of the dispute's data stream and become part of the email queue specific to the dispute. Using the All-Party New Info Notification system below, all parties are notified via email whenever entries are made with reference to the dispute.

Every action is available to every party classified as an Originating Party, Opposing Party or Participating Party. “Observers” and “Friends” are kept in the loop but are not included in the Resolution Rating System (see below), which is reserved only for parties in opposition.

If a dispute contains more an Originating Party, all other parties are noted in all communications and referenced via their nicknames. The only communication between parties is the communication provided within the system. Direct contact information (email addresses, names, locations, etc.) is never disclosed to any party for any reason while in the system.
C) Once the new party has become successfully verified, they are redirected to a Participating Party Data Entry Page. This page contains a textbox in which they may provide information they believe pertinent to the dispute, and the Universal Links detailed on Page 4 of this document, which includes a link to invite another party. Users must agree to the Terms and Conditions and Privacy Policy, accomplished by checking the provided checkbox.

Immediately after submitting new data on the Participating Party Data Entry Page the All-Party New Info Notification System is triggered.
D) The All-Party New Info Notification System sends an email notice to all parties to the dispute that someone or something has been added to the dispute. This email provides the Universal Links detailed on Page 4 in this document.

No theoretical limit exists for the number of parties that can participate in a dispute.

### Description: Ask-An-Expert Process Flowchart

The flowchart titled Ask-An-Expert Process Flowchart contained within the included Flowcharts document as Drawing 6 is a detailed depiction of the process within the system used to obtain an expert's opinion or advice with reference to the subject dispute. The process is triggered by the user's selection of a link, indicating their desire to receive an expert's opinion. The Ask-An-Expert trigger contains a reference to a specific dispute enabling the DataPacket to be fetched as and when necessary.

The Ask-An-Expert module is available only to logged-in users who are presently a party to a dispute. User's attempting to access this module that are not logged-in will be programmatically redirected to the login page.

References to the accompanying flowchart are made with lettered notations.
A) Upon entering the Ask-An-Expert module the user is first presented a Disclaimer Page to which they must agree. Failure to agree simply returns the user to the point in the system from which they selected the Ask-An-Expert link (the parent page).
B) The Expert Category Selection Page provides a dropdown list populated by the Categories database table in which every category of expert offered through the system is stored.
   Examples of Expert Categories: Accountant, Banker, Business Person, Clergy Person, Doctor, Electrician, Insurance, Lawyer, Nurse, Plumber, Substance Abuse, etc.
C) The Expert Finding Module queries the selected expert category against the Experts database table and returns a list of available experts within the selected category which match the disputer's localized language (i.e. English, Spanish, French, etc.), and the disputer's specific needs for expert opinion. The expert's specific areas of expertise stored in the Experts database table and keywords previously parsed from the dispute and stored in the Dispute Data database table are compared, then a selection of suitable matches is sent to the Expert Listing Page.
D) The Expert Listing Page displays matched experts as links. A brief summary of each of the matched expert's specific qualifications and their charges is accessible by clicking the link. The user is presented with the option of either selecting an expert from the list, returning to the Expert Category Selection Page, or leaving the Ask-An-Expert System and returning to the main Automated Dispute Resolution System. If the user selects an expert, they are sent to the Payment Processing Module.
E) The Payment Processing Module processes payment for an expert's services; typically by credit card or electronic funds transfer. After collecting the required payment data from the Payment Page and authorizing the payment the Expert Alert Module is triggered.
F) The Payment Page provides all fields necessary to securely process a credit card or electronic funds transfer payment. The collected data is processed by the Payment Processing Module (see “E” above).
G) The Expert Request Module is triggered by the Payment Processing Module upon the successful authorization of a sale. Using data sent with the trigger it fetches the appropriate DataPacket for the specific dispute, pairs it with the assigned expert's data, then sends everything to the Expert Administration Module.
H) The Expert Administration Module performs the following tasks:
   1. Sends data to the Communication Module.
   2. Provides a secure VPN portal through which the expert will administer the dispute.
   3. Provides the expert with pertinent dispute data.
   4. Updates the Dispute Data database with the expert's opinion/advice when it is rendered.
I) The Communication Module handles notifications specific to the Ask-An-Expert system upon direction from the Expert Administration Module. It is responsible for:
   1. User notification that an Expert has been alerted.
   2. Expert notification that a dispute is waiting.
   3. Providing the Expert with a link to the Expert Administration Module relative to the dispute.
   4. Notification of all parties through the All-Party New Info Notification system that the Expert's opinion/advice has been rendered and is available.
J) The Remote Expert is the Expert's personal computer through which they connect to the Expert Administration Module via secure VPN connection contained in an email. Using provided templates contained within the Expert Administration Module the expert renders their opinion/advice regarding the dispute.

### Description: Crowd Voting Process Flowchart

The flowchart titled Crowd Voting Process Flowchart contained within the included Flowcharts document as Drawing 7 is a detailed depiction of the process for obtaining the collective opinions of willing casual observers. It is triggered by the user's selection of a link that indicates their desire to access the anonymous consolidated opinion of willing, volunteer participants, also known as “a crowd.”

The Crowd Voting module is available only to logged-in users presently a party to a dispute. User's attempting to access this module who are not logged-in will be programmatically redirected to the login page.

The Crowd Voting trigger contains a reference to a specific dispute enabling the DataPacket to be fetched, thereby exposing a dispute's details without disclosing identities of the parties other than by nickname.

Crowd voting is only available when a dispute contains more than a single party.

References to the accompanying flowchart are made with lettered notations.
A) Upon entering the Crowd Voting module the user is first presented a Disclaimer Page to which they must agree in order to proceed. After agreeing, the User is redirected to the Crowd Voting Homepage. Failure to agree returns the user to the parent page.
B) The Crowd Voting Homepage provides the following functionality:
   1. An explanation of Crowd Voting and how it may help with dispute resolution.
   2. The real time number of prospective voters presently online.
   3. A menu of services and prices available to gain access to Crowd Voting, and a control to access their selection.
   4. The Universal Links detailed on Page 4 of this document.

If a User elects to proceed with a Crowd Voting option they are redirected to the Payment Processing System.
C) The Payment Processing System accepts and processes payment for the selected purchase and handles the authorization and collection of all payments.
D) The Participant, Details and Options Page lists the nicknames of all participants who will receive emailed results of the poll (by default, all parties). The paying party retains the exclusive option of excluding any party in the list, thereby preventing them from being directly notified of the polling results. The paying party may review dispute details entered by any participant by clicking on their nickname which exposes their entries.

Additional options allow the user to fine-tune polling details. Options may include a time limit for voting, or a number of votes threshold, allowing users to receive results only after a specified number of votes is reached.

After making their selections the User clicks on a Poll button which triggers the Vote Processing Module.
E) The Vote Processing Module is the brains behind the Crowd Voting System. Its responsibilities include:
   1. Collecting all dispute details from the database, including:
      a. User data
      b. Dispute data
   2. Collecting participants to be emailed polling results from the Participant, Details and Options Page.
   3. Collecting polling options.
   4. Formatting the Ballot.
   5. Collecting voting results.
   6. Formatting voting results for distribution.
   7. Transmitting results and the email list to the Voting Results Email module.
   8. Report polling results and update the Dispute Data database.
F) The Voting Results Email module processes outgoing emails to the selected participants and sends them the voting results, additional resolution suggestions, and relevant, location-based promotions, as well as the Universal Links detailed on Page 4 of this document.

### Description: Professional Referral System Process Flowchart

The flowchart titled Professional Referral System Process Flowchart contained within the included Flowcharts document as Drawing 8 is a detailed depiction of the process to find a suitable professional that may be willing able to help in the resolution of a dispute on a compensated basis. This process is triggered by the user's selection of a link indicating their desire to find a practicing and, where applicable, licensed professional to help in the resolution of a dispute. Attorneys, accountants, medical doctors and dentists comprise some of the types of professionals listed.

The Professional Referral System module is available only to logged-in users who are presently a party to a dispute. User's attempting to access this module who are not logged-in will be programmatically redirected to the login page.

The most noteworthy difference between this Professional Referral System and the previously detailed Ask-An-Expert system is that the Professional Referral System provides paid listings of professionals who are compensated for services rendered directly by the user, outside of this system. All communication and financial arrangements are between the referred professional and the user.

No data regarding the user or the dispute is shared with the referred professional other than a referral form generated by the system. The form contains a referral code and whatever incentive the Professional has requested be included. Example: “Free initial consultation.”

References to the accompanying flowchart are made with lettered notations.
A) Upon entering the Professional Referral System module the user is presented a Disclaimer Page to which they must agree. Failure to agree simply returns the user to the referring parent page. After agreeing, the user is directed to the Professional Category Selection Page.
B) The Professional Category Selection Page contains a dropdown list populated by the Categories database table and includes every category of professional referred by the system.

After selecting the desired category, the user's selection and location information are sent to the Professional Finding Module.
C) The Professional Finding Module performs the following tasks:
   1. Accepts input from the Professional Category Selection Page.
   2. Accepts input from the DataPacket containing the User's location.
   3. Queries the Professionals database table for the best matches based upon category and user location.
   4. Sends results to the Professional Listing Page.
D) The Professional Listing Page displays as links a list of professionals resulting from the Professional Finding Module query. The page contains controls allowing the user to specify a radius distance in miles and other profession-based parameters that will trigger an on-the-fly re-query and/or re-sort of the results, returning the updated information as fast as the new query can be completed.

The user selects a professional by clicking the desired link, which triggers the Professional Fetching Module.
E) The Professional Fetching Module performs the following functions:
   1. Queries the Professionals database table and retrieves the selected professional's record.
   2. Generates a Professional Referral Details email to the user.
   3. Redirects the user to the Check Your Email Page.
   4. Updates the Professionals database table by incrementing a referrals counter field, indicating that a lead has been generated for that professional.
   5. Updates the User Data database with a reference to the referred professional.
F) The Professional Referral Details email contains pertinent contact data which the user can use to contact the professional. It also contains any special incentive or promotion specified by the professional to attract new clients. Location-based promos and the Universal Links detailed on Page 4 of this document are included as well.
G) The Check Your Email Page alerts the user to watch for an incoming email that contains the requested information. It also contains the Universal Links detailed on Page 4 of this document.

### Description: Data Editing Process Flowchart

The flowchart titled Data Editing Process Flowchart contained within the included Flowcharts document as Drawing 9 is a detailed depiction of the process required to edit a dispute's details. It is triggered by the user's selection of a page or email link indicating their desire to add to the previously entered data.

The Data Editing function is available only to logged-in users who are presently a party to a dispute. User's attempting to access this module who are not logged-in will be programmatically redirected to the login page.

The user will only be provided the opportunity to select a Data Editing link once they have already logged into a dispute in which they are a verified party.

The user is never provided the opportunity to delete or change data previously entered in a dispute. This module only provides the ability to add new detail.

References to the accompanying flowchart are made with lettered notations.
A) Upon entering the Data Editing function data previously entered by the user is displayed. Nickname and email address fields are presented for the active user as inactive fields which do not allow modification. Likewise, Party Type and Reason fields cannot be changed as this would likely recast the dispute and render prior suggestions and responses irrelevant and/or invalid.

Users will be instructed to begin a new dispute in cases in which they want to change the Party Type or Reason.

Additional details may be entered by the user, and they will be appended to all previous details entered by that user. New entries are data and time stamped automatically.

All entries by other parties to the dispute are viewable by clicking on the user's nickname. One user may never alter another user's entries

When done adding details the user is redirected to the Confirmation Page.
B) The Confirmation Page allows the user to view their additions. They may choose to discard their entries, in which case they are redirected to the landing page; to edit their entries, in which case they are returned to the previous page, or; to accept their entries, in which case the following actions are triggered:
   1. Dispute data database table is appended to reflect the new entries.
   2. All parties in the dispute are notified of the changes via the All-Party New Info Notification system.
   3. Then user processing continues as follows:
      a. If the user entered the Data Editing function via page link, they are redirected to the parent page.
      b. If they entered the Data Editing function via email link they are sent a Confirmation Email which contains promotional incentives and the Universal Links detailed on Page 4 of this document.

### Description: Resolution Rating System Flowchart

The flowchart titled Resolution Rating System Flowchart contained within the included Flowcharts document as Drawing 10 is a detailed depiction of the process allowing recipients of suggested dispute resolutions the opportunity to rate the resolutions they received in exchange for promotional incentives.

Resolution rating is a key component of the collective intelligence inherent in the Automated Online Dispute Resolution System.

Suggested resolutions are returned in order of their rating. The most dominant component of resolution rating is determined by how well the resolution worked for other users with similar disputes. The information ascertained by the Resolution Rating System is the most important element within a resolution's record and quantifies a particular solution's track record as a viable resolution.

The Resolution Rating System module is available only to logged-in users who are presently a party to a dispute. User's attempting to access this module who are not logged-in will be programmatically redirected to the login page.

References to the accompanying flowchart are made with lettered notations.
A) The Resolution Detection Module contains an algorithm which detects delivery of a proposed resolution, then tracks the elapsed time since the last activity occurred within any given dispute. It assumes that if there is no activity for a specific number of days, the dispute may have been successfully resolved. When that happens, the Resolution Rating Email is triggered.
B) The Resolution Rating Email is sent to all verified participating parties in a dispute. It contains basic information identifying the dispute, a list of participant's nicknames, incentives for providing feedback, and a link to participate. Upon clicking the link the user is redirected to the Resolution Rating Page.
C) The Resolution Rating Page provides the user with a list of the resolutions proposed to help resolve the dispute. Radio buttons next to each resolution allow them to quickly and easily select the resolution that worked best. If more than 10 resolutions are offered, a pagination control is provided allowing the user to page-through all proposed resolutions until they locate the one they wish to select.

Once selected, the working resolution prompts the user to assign an effectiveness value on a scale of 1 through 5, with 5 being the best. Next they are prompted to add their comments.

After the user is satisfied with and submits their entries they are redirected to the Confirmation Page.
D) The Confirmation Page displays all of the user's selections and comments. They are prompted to either edit or accept. Incentives for the submission of their experience are reinforced (repeated) and, if they choose to submit their input they are sent a Confirmation Email. If they choose to edit their entries prior to submission they are returned to the Resolution Rating Page.
E) The Confirmation Email contains a recap of their feedback through the Resolution Rating System. The email contains the Universal Links described on Page 4 of this document and promotional incentives.

A link to the Dispute Review Page provides an easy path for the user to review the entire dispute and its results.

1. The embodiments of the invention in which an exclusive property or privilege is claimed are defined as follows: an internet website that provides the functionality to provide dispute resolution suggestions to users seeking to resolve disputes by providing a series of prompts and controls in which the user will enter the details of a dispute then receive resolution suggestions and relevant, location based promotional material via return email:

2. The method of claim 1 wherein, an assembly of web pages, web page controls, web forms, email forms, databases, and algorithms accept a user's input providing the user's description of a dispute, then upon algorithmic analysis of the user's entries provides the titles of stored resolution suggestions, if any, of similar disputes by way of the collective intelligence analysis of suggested stored resolutions pertaining to their similarity to the user's dispute and their success in effecting a resolution previously.

3. The method of claim 2 wherein, an algorithm that accepts as input a text stream and then compares the words and phrases within the text stream to stored words and phrases that are considered significant in the field of dispute resolution, then segregates and parses those words and phrases, thereby flagging them as significant elements to a dispute and its subsequent resolution, and then creates output consisting of the resulting words and phrases to be used by other elements of the invention in the identification of a potential resolution.

4. The method of claim 3 wherein, an automated Internet search function that accepts input in the form of the words and phrases collected previously and flagged as significant to the dispute, combines them with dispute elements identifying the type of entities engaged in the dispute, then formulates a query based upon the significant data collected, then searches the Internet for resolutions to disputes that closely match the user's dispute, then saves any resolutions found to a database for use as suggested resolutions for the user's dispute and future similar disputes.

5. The embodiments of the invention in which an exclusive property or privilege is claimed are defined as follows: a system by which additional parties can be invited to participate in or observe a dispute by an existing participant of said dispute and upon becoming a participant can then invite additional parties to participate in or observe the dispute and upon becoming a participant each of those additional parties can invite additional parties with no limit to the number of iterations of this process, or the number of parties that can either participate in or observe a dispute.

6. The embodiments of the invention in which an exclusive property or privilege is claimed are defined as follows: an Internet based system of online dispute resolution services in which a disputing party may request the opinion of an expert in a particular field of study and which said request is then programmatically matched to the most suitable expert qualified to opine based upon their area of expertise, experience, localization, availability, and location.

7. The embodiments of the invention in which an exclusive property or privilege is claimed are defined as follows: an Internet based system of online dispute resolution services in which a disputing party may seek and receive the opinion of other users willing to render their opinion in the form of a vote in favor of or against a particular party's stated position in the dispute via a real time online voting system consisting of an informal poll of anonymous observers whose opinions are gathered from any website, application, or web page upon which the polling system is posted, programmed, or linked.

8. The embodiments of the invention in which an exclusive property or privilege is claimed are defined as follows: an Internet based system of online dispute resolution services in which a user can seek and receive direct contact information for professionals actively practicing in specific dispute-relevant fields and who are located within a user-specified or programmatically ascertained geographic area.

9. The method of claim 1 wherein, a user receiving a dispute resolution suggestion through the system will be surveyed regarding the effectiveness of the suggested resolution as it pertains to its effectiveness with regard to resolving their dispute, and the results of said survey will become part and parcel of the stored resolution suggestion which may an impact upon said resolution's rating which may in turn may determine the resolution's ranking as a viable suggestion for use in future disputes.
